(19) United States
(12) Patent Application Publication
(10) Pub. No.: US 2024/0351925 A1
(43) Pub. Date: Oct. 24, 2024

(54) DEVICE AND METHOD FOR PURIFYING WASTEWATER

(71) Applicant: NXO ENGINEERING, Cournonsec (FR)

(72) Inventor: Cesar NARVAEZ, Cournonsec (FR)

(21) Appl. No.: 18/684,677

(22) PCT Filed: Aug. 16, 2022
(86) PCT No.: PCT/EP2022/072874

§ 371 Date: Mar. 5, 2024

(30) Foreign Application Priority Data
Aug. 17, 2021 (FR) FR2108719

(51) Int. Cl. C02F 3/28; B01D 53/047; B01D 53/26; C02F 3/00

(52) U.S. Cl. CPC C02F 3/2846; B01D 53/047; B01D 53/265; C02F 3/006; C02F 3/2893; B01D 2253/102; B01D 2253/108; B01D 2257/304; B01D 2257/80; B01D 2258/05; C02F 2201/005; C02F 2203/002; C02F 2209/03; C02F 2209/42; C02F 2301/046

(57) ABSTRACT

The device (100) for purifying wastewater comprises:
a vacuum anaerobic digester (105) comprising:
   in the lower part (110), an inlet (115) for wastewater,
   in the upper part (120):
a weir (125) for treated water comprising a water outlet (130) positioned at a first height (131) starting from the lower part and
a biogas outlet (135) positioned at a second height (136) higher than the first height,
   a riser column (140) for raising water by suction of the biogas from the lower part to the upper part,
   a downer column (141) for bringing down untreated wastewater from the upper part to the lower part and
   a vacuum pump (145) connected to the biogas outlet, and
   a buffer column (190) configured to receive wastewater.

### TECHNICAL FIELD OF THE INVENTION

The present invention relates to a device and a method for purifying wastewater. It applies, for example, to the field of urban wastewater purification.

### STATE OF THE ART

The shortage of water resources and climate change call for appropriate and fine-tuned management of the available water resources. In particular, the Mediterranean regions are facing an impending water shortage and require environmental protection technologies that:
incorporate conservation of the resource;
focus on minimising the use of energy and chemical products; and
promote the maximum re-use of cleaned urban wastewater (referred to as UWW) and residues produced from pollutants in the water.

Solutions of UASB (for “Upflow Anaerobic Sludge Blanket”) anaerobic reactor type are known, developed for the treatment of wastewater in the 1970s. This reactor is supplied by upward flow with no packing medium, and is equipped in its upper part with a three-phase separation system: gas, liquid and solid. This system allows the biogas to be evacuated, and reduces the output of matter in suspension (referred to as “MES”) in the effluent. Its hydraulic behaviour is perfectly mixed except at the location of the three-phase separator, which has the hydraulic characteristics of a piston reactor. Agitation of the medium is mainly due to the production of biogas. A good distribution of wastewater is necessary, in particular for water with a low concentration of COD (for “chemical oxygen demand”) generating little gas, to prevent the formation of preferential paths.

Biomass retention in sludge bed reactors is based on the ability of anaerobic microorganisms to flocculate in order to form granules that can reach 5 mm in diameter and have good sedimentation characteristics (volumetric index <20 mL·gMVS⁻¹; maximum settling velocity >5 m·h⁻¹), and good mechanical resilience. This prevents their leaching from the reactor in which the upflow velocity of the liquid is generally maintained between 1 and 1.5 m·h⁻¹.

The main problem with these systems lies in the formation and maintenance of granules. Granulation is a slow process that results in a long startup period (about six months) if unsuitable digester sludge is used as inoculum. Formation of a granular sludge is practically impossible with some types of effluent, and degranulation can be observed when the reactor that treats these effluents is seeded with a sludge that is already granulated. Sludge bed methods are also sensitive to the sludge concentration in the MES. Indeed, a low upflow velocity does not enable the leaching of particulate matter, which can cause their accumulation at the expense of the formation of granules, thus leading to a reduction in the biological activity. The resolution of these problems entails better knowledge of the intimate mechanisms of the granulation and of the factors that govern it. The granules are formed solely of microorganisms. It is generally agreed that their formation is the result of the selection of flocculated bacteria in an upflow system where the free cells in suspension are necessarily leached. The granules also have a very complex bacterial organisation. Their fermentative, syntrophic and methanogenic microorganisms are closely associated with each other, which reduces the distance between them. The inter-species transfer of hydrogen and the dispersion of metabolites along the trophic chain are more efficient.

Integrating the UASB technology as pretreatment method for the UWW has the following disadvantages:
low removal of pathogens and nutriments;
long inoculation and maturation time;
requires post-treatment; and
potential unpleasant odours if the reactor is poorly managed.

Mixing inside the UASB reactor is a key parameter. One of the greatest technological advances in high-load anaerobic methods is the possibility of separating the hydraulic residence time (acronym “HRT”) from the sludge residence time (acronym “SRT”). Unlike aerobic systems, in anaerobic or anoxic processes the maximum acceptable load is dependent on the maximum level of reactant that can be supplied (e.g. oxygen during aerobic reactions), but in UASB digesters the performance is governed by the amount of viable anaerobic biocatalysts, i.e. the anaerobic bacterial biomass, having maximum contact with the constituents of the wastewater. There have been many changes to the UASB since its invention. Thus, some researchers have replaced the gas-solid separator in the top of the reactor by a fixed bed with ascending flow (referred to as “UASB-FA”). Other teams have adapted the fluidisation conditions of a fluidised bed (liquid and gas velocities) to sludge beds so as to obtain the expansion of the granules and handle various chemical, biochemical and biotechnological discharges at high load. This reactor, called EGSB (for “Expanded Granular Sludge Bed”), handles higher pollution loads because the dead zones are limited, which boosts the sludge/effluent contact. EGSB combines recirculation of the effluent at upflow velocities greater than 4 m·h⁻¹ and higher reactor geometries (high height/diameter ratio).

Compartmentalisation of the reactor space has led to the internal circulation (acronym “IC”) reactor, which comprises two UASB reactors superimposed. The lower reactor operates at high load and the biogas produced is recovered for the fluidisation of the second reactor, by gas lift effect, located above and supplied at low load.

Although the UWW is considered to be diluted effluents (COD<1000 mg·L⁻¹), it has the characteristics of a complex effluent, with a low temperature (fluctuating between 15 and 25° C.) and a high MES ratio of approximately 50-65%, i.e. a low ratio of soluble COD to the total COD. Consequently, the total conversion of the COD is limited by the hydrolysis phase of solid compounds. The management and yields of this methanation technology are highly dependent on the temperature. As with all chemical and biochemical transformations, the speed of the reactions that occur in methanation increases with the temperature. However, these systems are very dependent on their operating temperature.

Patent application US 2020 392 025 and patent U.S. Pat. No. 8,721,877 are known, which disclose devices for treating wastewater solids and gas. However, such devices operate at atmospheric pressure and therefore do not make it possible to boost the evaporation of the biogas partially dissolved in the treated water and thus an optimum recovery of the biogas. In addition, such devices do not make it possible to obtain treated water having a maximised COD value, in particular associated to a reduced concentration of residual pollutants. Lastly, the treated water obtained by these devices has a level of floats that is still high, this treated water consequently not having a good quality that makes it possible to comply in particular with the required specifications.

Therefore, there is no satisfactory system making it possible to optimise mixing inside the reactor while enabling the facilitated extraction of biogas coming from the reactor.

### DESCRIPTION OF THE INVENTION

The present invention aims to remedy all or part of these drawbacks.

To this end, according to a first aspect, the present invention envisages a purification device according to claim 1.

Thanks to these provisions, it is possible to create a first step of energy recovery in an urban wastewater (UWW) cleaning chain.

This makes it possible to clarify the UWW and transform the pollution into methane. These provisions offer three advantages, in particular:
hydraulic transport, through the riser column suction effect, at low energy cost, aimed at optimising the mixing in the digester (boosting contact between the sludge, anaerobic catalysts, and reaction medium);
easy extraction of biogas, because the saturation pressure is preferably below atmospheric pressure (the dissolution constant of a gas is proportional to the pressure in the chamber); and
close to optimum control and removal of the sludge.

Mixing inside the reactor improves as biogas extraction increases. If the mixing is optimum, the better the performance of the reactor in terms of converting the pollution into methane. In addition, the presence of a buffer column makes it possible, in particular, to optimise the operation of the digester. In effect, such a buffer column makes it possible to start a flow of wastewater towards the digester based on hydrodynamic constraints imposed by the digestion process. In particular, such a flow, or hydraulic circulation, is triggered according to the principle of communicating vessels when a vacuum is applied in the upper part of the digester. In addition, the buffer column, with the flow it triggers during the implementation of the digestion process performed by the digester, contributes to the application of a sufficient vacuum, and in particular a negative pressure, in the upper part of the digester and above the supernatant water.

In some embodiments, the digester comprises a bottom outlet for treated water, connected to the weir and positioned at a third height starting from the lower part, said third height being lower than the first height of the weir. When the treated water outlet is placed at the bottom of the digester, the treated water can be evacuated without air suction by this treated water outlet. In this case, such an evacuation is performed despite a negative pressure, or vacuum, applied in the upper part of the digester.

In some embodiments, the third height of the treated water outlet is lower than or equal to the level of treated water in the buffer column. Thanks to these provisions, the evacuation of treated water is easily performed, for example, in the lower part of the digester. In particular, such an evacuation is optimised by the hydraulic pressures generated in the device.

In some embodiments, the treated water outlet also comprises an extraction valve for extracting water from the weir. Thanks to these provisions, the evacuation of treated water is performed during the opening of the extraction valve. In this way, an adjustable flow rate of treated water is generated, in particular based on wastewater treatment constraints, such as the volume of this wastewater to be treated or the volume of treated water to be generated.

In some embodiments, the device that is the subject of the invention comprises a sensor for detecting the presence of water in the weir, at least the extraction valve being activated based on the detected presence of water. These embodiments enable a transition from one configuration, in which the pressure of the digester evolves towards a nominal pressure, to a configuration in which the device is in nominal operation. These embodiments allow the valve to be kept in the closed position when water has not been detected at this level, to prevent air from entering the reactor.

In some embodiments, the device that is the subject of the invention also comprises:
an inlet for recirculated biogas in the lower part of the digester; and
a recirculation pipe for recirculating biogas from the biogas outlet to the biogas inlet.

These embodiments make it possible to boost sludge mixing in the lower part of the digester.

In some embodiments, the device that is the subject of the invention also comprises a valve for activating the recirculation pipe. These embodiments, when the device comprises a valve for extracting water from the weir, allow the device to have distinct modes of operation based on the opening and closing of valves.

In some embodiments, the device that is the subject of the invention has a mode of operation in which the valve for activating the recirculation pipe and the valve for extracting water are closed. These embodiments enable a reduction in the pressure of the reactor suitable for preparing the device for nominal operation, making possible a maximum extraction of the biogas and water.

In some embodiments, the device that is the subject of the invention also comprises:
a pressure sensor, configured to detect an operating pressure in the upper part of the digester; and
a proportional-integral-derivative regulator, configured to regulate the operation of the vacuum pump based on the pressure detected in the upper part of the digester.

These embodiments enable the device to optimally achieve an operating working pressure.

In some embodiments, the digester also comprises an open tank, the riser column for raising water by suction of biogas of water comprising, in the upper part of the digester, an outlet for the raised biogas, said outlet being connected to the open tank and positioned at a fourth height lower than the first height. These embodiments make it possible to separate the sludge, the water and the biogas obtained in the digester.

In some embodiments, the riser column for raising biogas is at least partially surrounded by a settling zone.

In some embodiments, a fifth height defining the limit of the settling zone is lower than the first height of the weir. Thanks to this disposition, the settling zone makes it possible to limit the amount of particles in suspension, in particular floats, reaching the first height of the weir for treated water. The COD of the treated water is therefore lowered. As a result, the quality of the treated water is improved.

In some embodiments, the settling zone comprises a lamella settler. Thanks to this disposition, the settling zone makes it possible to further limit the amount of pollutant particles in suspension in the treated water. The settling is therefore optimised, thus making it possible to improve the quality of the treated water.

In some embodiments, the digester also comprises a gas-liquid-solid separator communicating with a lower end of the water riser column, the separator being substantially conical in revolution and with a top arranged inside the water riser column, and being configured to carry at least biogas in the water riser column. Thanks to these provisions, the separator makes it possible to direct the biogas and water to the water riser column while restricting the raising of solid particles.

In some embodiments, the conical separator has a base, and the digester also comprises a deflector:
arranged at a sixth height lower than the base of the separator;
having an end projecting orthogonally onto the base of the separator; and
configured to direct the flow of biogas towards the base.

Thanks to these provisions, the deflector enables biogas to be accumulated over a lower part and then the biogas flow to be directed towards the separator. In particular, the excess biogas not retained by the lower part rises towards the base of the separator, being guided by the end of the deflector, and is then carried towards the water riser column to achieve the raising of water drawn by the gas, also called the “gas lift” effect. The cooperation between the separator and the deflector therefore enables an optimised gas lift effect. As a result, the homogenisation of the mixture in the digester is optimum.

In some embodiments, the device that is the subject of the invention comprises:
a level sensor for detecting a wastewater fill level in the buffer column; and
a supply pump for supplying the buffer column with wastewater activated based on the detected fill level.

These embodiments make it possible to automatically regulate the amount of wastewater in the buffer column. In such embodiments, a “PID” type of regulation can be utilised, in which the operating frequency of the pump is servoed to the liquid level of the buffer column.

In some embodiments, the device that is the subject of the invention comprises, downstream from the vacuum pump:
a dehumidifier of the biogas;
an adsorption means for purifying the biogas; and/or
a storage for the biogas.

These embodiments enable the biogas to be treated in order to comply with recovery specifications set.

In some embodiments, the digester comprises:
a thermal chamber configured to receive a flow of warm water, comprising a water inlet and a water outlet;
a warm water circuit comprising:
a water pump connected to the water outlet of the chamber, and
a heat exchanger configured to heat or cool the warm water, the water on output from the heat exchanger being supplied to the water inlet of the chamber.

These embodiments make it possible to automatically regulate the operating temperature of the digester.

According to a second aspect, the present invention envisions a method for purifying wastewater according to claim 19. As the particular features, advantages and aims of this method correspond to those of the device that is the subject of the invention, they are not repeated here.

### BRIEF DESCRIPTION OF THE FIGURES

Other advantages, aims and particular features of the invention will become apparent from the non-limiting description that follows of at least one particular embodiment of the device and method that are the subjects of the invention, with reference to drawings included in an appendix, wherein:

FIG. 1 represents, schematically, a particular embodiment of the device that is the subject of the invention;

FIG. 2 represents, schematically, the device represented in FIG. 1, before the start of such a device;

FIG. 3 represents, schematically, the device represented in FIG. 1, during the utilisation of such a device; and

FIG. 4 represents, schematically and in the form of a logic diagram, a series of steps of a particular embodiment of the method that is the subject of the invention.

### DESCRIPTION OF THE EMBODIMENTS

The present description is given in a non-limiting way, in which each characteristic of an embodiment can be combined with any other characteristic of any other embodiment in an advantageous way. Hereafter, “valve” refers to any known type of valve suitable for the use indicated contextually. Such a valve is, for example, a motorised valve. Note that the figures are not to scale.

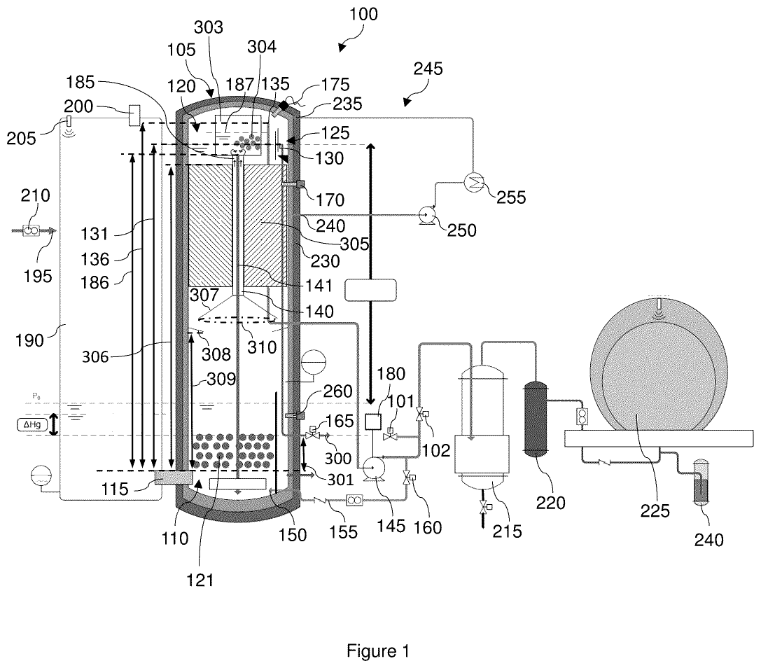

FIG. 1, which is not to scale, shows a schematic view of an embodiment of the device 100 that is the subject of the invention. This device 100 for purifying wastewater comprises a vacuum anaerobic digester 105 comprising:
in the lower part 110, an inlet 115 for wastewater;
in the upper part 120:
   a weir 125 for treated water comprising a water outlet 130 positioned at a first height 131 starting from the lower part; and
   a biogas outlet 135 positioned at a second height 136 higher than the first height.

The device 100 also comprises:
a riser column 140 for raising water by suction of the biogas from the lower part to the upper part;
a downer column 141 for bringing down untreated wastewater from the upper part to the lower part; and
a vacuum pump 145 connected to the biogas outlet and configured to cause, when said pump is actuated, the flow of water from the lower part to the upper part.

Anaerobic digester 105 refers to a tank used in the methanation process that produces biogas by means of a method for the anaerobic digestion of organic matter from various sources. Here, preferably, the organic matter comes from urban wastewater. The digester 105 is referred to as a “vacuum” digester, i.e. its preferred operating conditions are at a pressure generally below atmospheric pressure. The digester 105 is formally divided into two parts: a lower part 110 and an upper part 120, whose relative proportions can vary. The term “lower part 110” refers generally to the part of the digester 105 generally close to the base, i.e. to the ground, when the digester 105 is in operating condition. The lower part 110 therefore refers to the area that receives the gravity flows occurring in the digester 105. This digester 105 can utilise different internal devices able to interact with the flow streams of biogas, water and/or organic waste. For example, as shown in FIG. 1, the digester 105 can utilise a flow device with grooves or fins configured to distribute the flows uniformly in the lower part 110. Such devices make it possible to prevent the accumulation of sludge in a specific location of the digester 105, which can deactivate it or at least reduce its performance.

In the lower part 110, the device 105 comprises an inlet 115 for wastewater. Such an inlet 115 corresponds to an opening, preferably connected to a tube, and optionally associated to a means for controlling a valve governing the opening and/or closing of the inlet. Such a valve can be actuated manually or automatically, using a programmable logic controller, according to preferred operating values of the digester 105. The lower part 110 of the digester 105 also comprises a bed of microorganisms, such as bacteria, selected for their ability to digest the UWW and produce biogas. In particular, such a digestion by the bacteria is carried out without oxygen and therefore corresponds to an anaerobic digestion. Such microorganisms can be supported by granules 121, for example bacterial granules referred to as “UASB”, arranged at the bottom of the tank (i.e. in the lower part 110) of the digester 105.

It is noted that a bacteria bed in a digester 105 is generated using a method known to the person skilled in the art, for example by introducing bacteria into the digester 105, also called digester inoculation, or by progressively introducing wastewater to be treated that contains bacteria which will, over time, create UASB granules. The wastewater therefore exhibits an upward flow in the transverse surface of the reactor, except in the column 141 where the water descends.

The lower part 110 and upper part 120 of the digester 105 are connected by a riser column 140 for raising water by suction of the biogas from the lower part 110 to the upper part 120. The lower part 110 and upper part 120 of the digester 105 are also connected by a downer column 141 for bringing down untreated wastewater from the upper part to the lower part. The columns 140 for raising water by suction of the biogas and 141 for bringing down water are, for example, coaxial.

In some variants, the digester 105 comprises a means for collecting wastewater raised by the effect of the suction of the biogas through the riser column 140. This wastewater is directed towards the downer column 141 for bringing down untreated wastewater to the lower part of the digester 105.

During the utilisation of the vacuum pump 145, the water in the lower part 110 is sucked up to the upper part of the digester 105. The riser 140 and downer 141 columns increase the mixing within the reactor by channelling the biogas towards the centre.

In the upper part 120, the digester 105 mainly comprises outlets for the different species of interest generated. Firstly, an outlet 130 for water supplied by a weir 125 whose function consists of allowing water to exit that exceeds a predefined height, called the first height 131, a function of the vacuum level, which is set as a function of the total height of the reactor, chosen to correspond to the height reached by the water once treated by the microorganisms.

“Outlet” of the weir 125 refers here, for example, to a wall for retaining liquids, wherein the crossing of the wall constitutes the outlet 130, in a similar way to a hydraulic weir.

“Height” refers to a value of a physical quantity representative of the distance between the base and a given point of the digester 105 along a gravitational vertical axis. In addition, the height can also be measured from the highest point of the tank or any other reference point located at a higher elevation than the point of interest whose height is measured when the digester 105 is in operating conditions.

In some preferred variants, the weir 125 is connected to a pipe for the vertical flow of treated water towards the lower part 110, gravitationally or by means of a pump, so as to counteract the effect of the negative pressure in the upper part 120 of the digester 105 when the water exits from the digester 105.

In some embodiments, such as those shown in FIGS. 1, 2 and 3, the digester 105 comprises a bottom outlet 300 for treated water, connected to the weir 125. In particular, such a bottom outlet 300 for treated water is positioned at a third height 301 starting from the lower part, the third height 301 preferably being lower than the first height 131 of the weir 125.

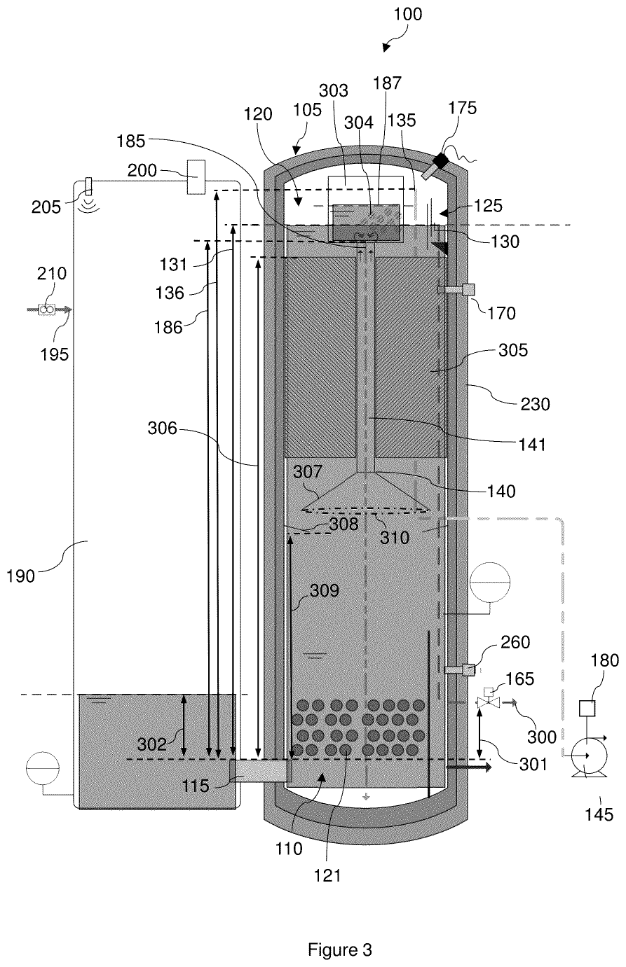

In some embodiments, such as the one shown in FIG. 3, the third height 301 of the bottom outlet 300 for treated water is lower than or equal to the level of wastewater 302 in the buffer column 190. In other words, the buffer column 190 comprises wastewater, the surface of this wastewater being at a height 302 at least equal to a third height 301 of the outlet 300 for treated water. Preferably, the third height 301 of the bottom outlet 300 for treated water is lower than the level of wastewater 302 in the buffer column 190.

Note that the device 100 shown in FIG. 3 corresponds to a mode of operation of the digester 105 when anaerobic digestion is utilised. In particular, in the digester 105, the pressure applied in the upper part and above the supernatant water is negative, for example equal to −0.5 bar. In this mode of operation shown in FIG. 3, it is noted that, for example, the water flows into the weir 125 and therefore has a level at a first height 131.

In some embodiments, such as those shown in FIGS. 1, 2 and 3, a bottom outlet 300 for treated water also comprises a valve 165 for extracting water from the weir 125. For example, an extraction valve 165 is a motorised valve. In some embodiments, the water extraction valve 165 is coupled to a water extraction pump.

In other words, when:
the water in the digester 105 has reached a height 131 matching the height of the weir; and
the outlet 130 for water from the weir 125, such as a pipe 130 connected to the weir 125, is filled with water,

the water extraction valve 165 is open for the evacuation of the treated water.

Preferably, such an opening is carried out following a command sent by a sensor for detecting the presence of water in the weir 125. At that time, in the pipe 130, the value of hydrostatic pressure will be greater than the value of the vacuum and the flow of treated water will take place with no suction of outside air. In particular, when the outlet 130 for water from the weir 125, such as a pipe 130 connected to the weir 125, is filled with water, such filling corresponds to a liquid seal and prevents the suction of air that can occur when the water extraction valve 165 is open.

In some embodiments, such as that shown in FIG. 1, the device 100 comprises a sensor 170 for detecting the presence of water in the weir 125, at least the extraction valve 165 being activated based on the detected presence of water.

The sensor 170 is, for example, a capacitive sensor activated by the presence of water in the weir 125. The detection of water can correspond to a change of operational regime of the device 100, from a start-up phase to a phase of nominal operation. These changes of regime are described below.

Secondly, the digester 105 comprises a biogas outlet 135, comprising for example a biogas extraction tube, an opening of which is positioned at the second height. The outlet 135 is configured to suck up the biogas located above the purified water, and water sucked up by the downer column 141.

The movement of the water in the digester 105 is induced by the action of the vacuum pump 145 configured to generate a low pressure, at the location of the biogas outlet 135, below the pressure of the UWW on input to the digester 105.

In some embodiments, such as that shown in FIG. 1, the device 100 comprises:
an inlet 150 for recirculated biogas in the lower part 110 of the digester 105; and
a recirculation pipe 155 for recirculating biogas from the biogas outlet 135 to the biogas inlet 150.

The biogas inlet 150 is, for example, structurally similar to the wastewater inlet 115 in the different variants presented. The recirculation pipe 155 is, for example, a tube configured to connect the downstream of the vacuum pump 145 and the biogas inlet 150 in the lower part 110 of the digester 105. This recirculation pipe 155 can be associated to a set of valves whose selective activation makes it possible to force all or part of the biogas flow towards said recirculation pipe 155. In a minimalist variant, the vacuum pump 145 is connected to a biogas evacuation pipe and the recirculation pipe 155 is a branch on this evacuation pipe, the branch and evacuation pipe each being associated to a separate valve, the opposing activation of which results in the biogas passing through either the evacuation pipe or the recirculation pipe 155.

In some variants, the recirculation pipe 155 is associated to a gas pump and/or a check valve upstream from the inlet 155.

In some embodiments, such as that shown in FIG. 1, the device 100 also comprises a valve 160 for activating the recirculation pipe 155. An example of realisation of the activation valve 160 is presented above, while the valve 165, functionally, makes it possible to extract water from the weir 125, i.e. when the extraction valve 165 is closed, the water collected by the weir 125 remains under the same pressure environment as the rest of the digester 105. The water exiting from the weir can be recovered in many ways.

In some embodiments, such as that shown in FIG. 1, the device 100 has a mode of operation in which the valve 160 for activating the recirculation pipe 155 and the water extraction valve 165 are closed.

Such a mode of operation corresponds to a start-up or initialisation phase of the device 100 in which the vacuum is created in the digester 105. For the vacuum to be created, the outlets and inlets of the digester 105 must be in the closed position. As the vacuum is created, the water raises along the digester 105, from the lower part 110 to the upper part 120, until the treated water enters the weir 125. When the water enters the weir 125, a valve 165 is opened, allowing the treated water to exit. Other operating regimes are described below.

In some embodiments, such as that shown in FIG. 1, the device 100 also comprises:
a pressure sensor 175, configured to detect an operating pressure in the upper part 120 of the digester 105; and
a PID regulator 180, configured to regulate the operation of the vacuum pump 145 based on the pressure detected in the upper part of the digester 105.

The pressure sensor 175 can be any type known to the person skilled in the art that matches the operating conditions of the device 100, in particular in terms of temperature, pressure or humidity. The PID, for “proportional-integral-derivative”, regulator 180 is a control system making it possible to improve the performance of a servocontrol, i.e. a closed-loop system or method. Here, the vacuum pump 145 is servoed to the pressure detected by the sensor 175.

In some embodiments, such as those shown in FIGS. 1, 2 and 3, the digester 105 also comprises an open tank 303. Such a tank is called “open” because it has an opening, at least partial, communicating with the upper part of the digester 105 in which a negative pressure, also called a vacuum, is applied. In other words, during the utilisation of the digester 105, the pressure inside the open tank 303 is equal to the low pressure applied by the vacuum pump 145 in the upper part of the tank, especially above the supernatant water. It is noted that such a tank is connected to the riser column 140 for raising water 140.

In some embodiments, such as those shown in FIGS. 1, 2 and 3, the riser column 140 for raising water by suction of the biogas 304 comprises, in the upper part 120 of the digester 105, an outlet 185 for the raised biogas 304, the outlet being:
connected to the open tank 303; and
positioned at a fourth height 186 lower than the first height 131.

This height differential is due to the level of gas retention in the zone above the riser column 140 for raising water by suction of the biogas.

This makes it possible to observe a double imbalance:
the biogas outlet 135 is located at a higher elevation than the outlet 130 for water from the weir 125;
the outlet 185 for water from the column 140 is located at a lower elevation than the outlet 130 for water from the weir, and at a lower elevation than the biogas outlet 135. The liquid level in this sector, especially inside the open tank 303, is higher through the “gas lift” effect, i.e. by the ascension of the biogas drawing wastewater up. This liquid level is shown by a second striped line 187.

In other words, the column 140 enables water to be raised, through the gas lift effect, with the biogas, corresponding to a gas-liquid two-phase mixture. At the location of the outlet 185 for water from the column 140 inside the open tank 303, the two-phase mixture will settle:
the biogas will be sucked up in the upper part of the digester 105 at the location of the biogas outlet 135; and
the water will descend again in the untreated wastewater downer column 141, such as a pipe, having an outlet towards the sludge bed zone to optimise the mixing.

In some embodiments, such as those shown in FIGS. 1, 2 and 3, a biogas riser column 140 is at least partially surrounded by a settling zone 305. Such a settling zone 305 is also called a clarification zone. Preferably, a fifth height 306 defines the limit of the settling zone 305. More preferably, the fifth height 306 is lower than the first height 131 of the weir 125. It is noted that such a settling zone makes it possible to boost the settling, and therefore the separation of floats and matter in suspension in the water.

In some embodiments, the settling zone 305 comprises a lamella settler. It is noted that a lamella settler has plates arranged in parallel in order to increase the settling surface area. The blades are arranged obliquely so as to guide the sliding of settled matter and floats towards the bottom of the lamella settler.

In some embodiments, such as those shown in FIGS. 1, 2 and 3, the digester 105 of the device 100 also comprises a gas-liquid-solid separator 307 communicating with a lower end of the water riser column 140. Preferably, the separator 307 is substantially conical in revolution and has a top arranged inside the water riser column 140. It is noted that such a separator 307 is configured to carry at least biogas to achieve the gas lift effect in the water riser column 140. In addition, the conical separator 307 has a base 310, shown by a dashed circle.

In some embodiments, such as those shown in FIGS. 1, 2 and 3, the digester 105 also comprises a deflector 308:
arranged at a sixth height 309 lower than the base 310 of the separator 307;
having an end projecting orthogonally onto the base 310 of the separator; and
configured to direct the flow of biogas 304 towards the base 310.

In these embodiments, a portion of the water initially present in the lower part of the digester 105 circulates towards the settling zone 305, passing between the space delimited by the base 310 of the separator 307 and the end of the deflector 308.

In some embodiments, such as that shown in FIG. 1, the device 100 comprises a buffer column 190 configured to receive wastewater, said column comprising:
a wastewater inlet 195;
an atmospheric air intake 200; and
the inlet 115 for wastewater from the digester 105 being connected to the buffer column 190 and configured to supply wastewater by means of a vacuum.

The main function of the buffer column 190 is to serve as a tank from which, by suction, water to be treated is sucked towards the digester 105. The inlet 195 is, for example, similar to the inlet 115 of the digester 105. The atmospheric air intake 200 is, for example, an opening to the environment outside the device 100, optionally able to be closed or not by means of a plug or valve. When the buffer column 190 is present, the wastewater inlet 115 can be reduced to a pipe, not being blocked or able to be closed, between the digester 105 and the buffer column 190.

In some embodiments, such as that shown in FIG. 1, the device 100 comprises:
a level sensor 205 for detecting a wastewater fill level in the buffer column 190; and
a supply pump 210 for supplying the buffer column 190 with wastewater, activated based on the detected fill level.

The sensor 205 is, for example, an ultrasound sensor. When the detected fill level is below a predefined limit value, or a dynamic value calculated based on the flow rate of the vacuum pump 145 or the pressure detected inside the digester 105, the pump 210 is, for example, configured to inject wastewater into the buffer column 190. Conversely, when the detected fill level is above a predefined limit value, or a dynamic value calculated based on the flow rate of the vacuum pump 145 or the pressure detected inside the digester 105, the pump 210 is, for example, configured to stop injecting wastewater.

In some embodiments, such as that shown in FIG. 1, the device 100 comprises, downstream from the vacuum pump 145:
a dehumidifier 215 of the biogas;
an adsorption means 220 for purifying the biogas; and/or
a storage 225 for the biogas.

The dehumidifier 215 is, for example, a condenser of residual water vapour present in the biogas. The adsorption means 220 is, for example, an adsorption column with activated carbon or another porous adsorption medium such as silica or zeolites. In some variants, if the biogas quality required on output must be higher, the adsorption means 220 can also be more complex, for example “PSA” (for “Pressure Swing Adsorption”) type. The storage 225 can be a transport channel or a tank, for example.

Preferably, the device 100 also comprises:
a dehumidifier 215 of the biogas;
an adsorption means 220 for purifying the dehumidified biogas; and
a storage 225 for the purified biogas.

In some embodiments, the digester 105 comprises:
a thermal chamber 230 configured to receive a flow of warm water, comprising a water inlet 235 and a liquid seal for protection of the gas holder 225;
a warm water circuit 245 comprising:
a water pump 250 connected to the water outlet 240 of the chamber 230; and
a heat exchanger 255 configured to heat or cool the warm water, the water on output from the heat exchanger 255 being supplied to the water inlet 235 of the chamber 230.

Two operating regimes are presented below. In the two examples, the startup condition is achieved when the liquid level is at a height of one metre in the buffer column and in the digester 105.

In the first operating regime, referred to as “regulated operation”, the steps of the following process are carried out:
firstly, an outlet valve 165 for treated water from the digester 105 is closed to prevent the suction of atmospheric air inside the digester 105 making priming the device 100 impossible,
opening a priming valve 101 and closing a biogas extraction valve 102 and a biogas recirculation valve 160,
actuating the vacuum pump 145 until a setpoint pressure is reached, dependent on the height of the digester 105 chosen—in this example, the digester 105 is six metres high, thus a pressure of 500 mbarA (−0.5 barG),
maintaining the setpoint pressure by PID regulation between a differential frequency converter of the vacuum pump 145, and a pressure sensor 175 installed in the upper part 120 of the digester 105 (the speed of the vacuum pump is servoed to the pressure),
regulating the level of liquid inside the buffer column 190 by PID between the speed of the pump supplying the UWW, and the level of liquid detected by the sensor 205,
introducing pre-treated UWW into the buffer column 190 (after a screening method at the water treatment plant head, for example), filling the digester 105 by means of a vacuum,
opening the water outlet valve 165 when the sensor 170 for detecting the presence of water is activated by the presence of water,
closing the priming valve 101 and opening the extraction valve 102,
the treated water is discharged because the water channel is located in a positive pressure zone; the level of the liquid of the buffer column 190 and the outlet balance based on the flow rate of the water at the inlet 115,
the system operates in a stable manner; the treated water exits from the digester 105 through a dedicated outlet 130 and a circulation loop inside the digester 105 is created by the lift effect of the biogas amplified by the vacuum; the level of gas retention increases with the vacuum level,
the biogas produced is extracted by the vacuum pump 145 and goes through a step of removing pollutants that can be absorbed in the vacuum network (foams and scum) via a tank of condensates,
the biogas then goes through a step of dehumidification; the condensates are removed by gravity,
the biogas next passes through a means for adsorption by extruded activated carbon or any other adsorbent material to remove the species H₂S,
the biogas is stored in a double-membrane gas holder (30 mbarsG) until it is used; a 50 mbarsG liquid seal 240 is associated to this device 100,
the granular sludge is evacuated when the surplus sludge compartment is full; at this stage, a probe 260, for example capacitive, actuates the time-delayed procedure for discharge to a zone for solar dehydration (sludge mineralisation),
the height of the compartment is sufficient for the granular sludge stored to have a solid retention time (abbreviation “SRT”) equivalent to 30 days (psychrophilic conditions 12-25° C.), to ensure it is correctly hygienised by anaerobic digestion, and
the digester 105 can be thermally regulated by means of the circulation of warm water in the circuit 245 and the thermal insulation.

All or part of this example can be implemented in an advantageous embodiment benefiting, individually or synergistically, from the unitary advantages conferred by these parts.

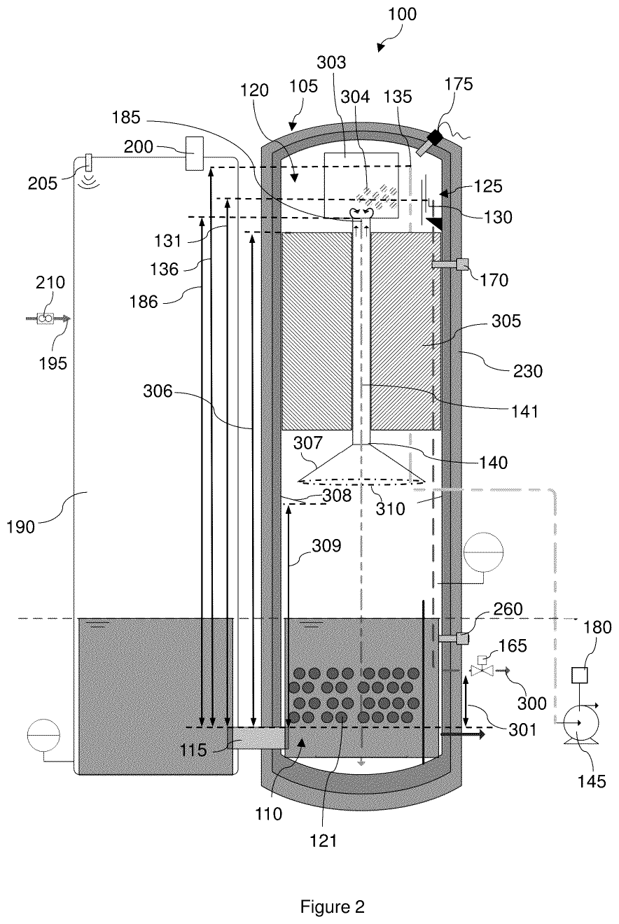

FIG. 2, which is not to scale, shows a schematic view of an embodiment of the device 100 that is the subject of the invention. In FIG. 2, it is noted that the device 100 is not in operation, i.e. the vacuum pump 145 is not activated. In other words, in FIG. 2, the device 100 has not yet been started, and no negative pressure for realising a vacuum has been applied. FIG. 2 shows that the level of wastewater in the buffer column 190 is equal to the level of wastewater in the digester 105 through the equilibrium of pressures. In other words, the surfaces of the wastewater in the buffer column 190 and the digester 105 are at atmospheric pressure.

FIG. 3, which is not to scale, shows a schematic view of an embodiment of the device 100 that is the subject of the invention. In FIG. 3, it is noted that the device 100 is in operation, i.e. the vacuum pump 145 is activated and a constant vacuum, also called a negative pressure, is applied in the upper part of the digester 105. FIG. 3 shows that the level of wastewater in the buffer column 190 is lower than the level of wastewater in the digester 105. In particular, the surface of wastewater in the buffer column 190 is at atmospheric pressure, and the surface of wastewater in the digester 105 is subjected to a relative negative pressure, for example relative to atmospheric pressure. Such a negative pressure is, for example, equal to −500 mbarG.

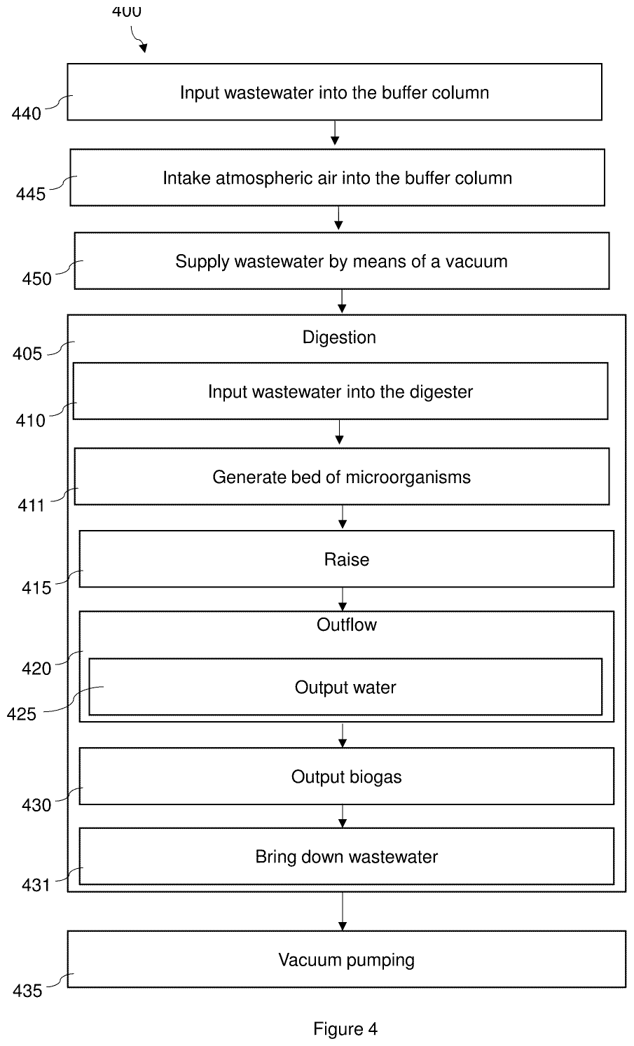

FIG. 4 shows, schematically and in the form of a logic diagram, an embodiment of the method 400 that is the subject of the invention. This method (400) for purifying wastewater comprises:
a step 405 of anaerobic digestion under vacuum, in a digester, comprising:
a step 410 of inputting wastewater into the lower part of the digester;
a step 411 of generating a bed of microorganisms in the lower part of the digester, the microorganisms comprising bacteria;
a step 415 of raising water, in the riser column of the digester, from the lower part to an upper part of the digester;
a step 420 of the outflowing of treated water, by a weir in the upper part of the digester, comprising a step 425 of outputting water in a water outlet of the weir for water positioned at a first height;
a step 430 of outputting biogas, through a biogas outlet positioned at a second height higher than the first height;
a step 431 of bringing down wastewater, in a downer column, from the upper part to the lower part of the digester; and
a step 435 of vacuum pumping connected to the biogas outlet and configured to cause, when said pump is actuated, the flow of water from the lower part to the upper part; and
a step 440 of inputting wastewater into a buffer column;
a step 445 of intaking atmospheric air into the buffer column; and
a step 450 of supplying, by means of a vacuum, wastewater in the buffer column to the digester, the digester being connected to the buffer column.

In some embodiments, the method 400 also comprises, before the outflow step 420, a settling step for separating the water and solid matter. These steps have been described, mutatis mutandis, with reference to FIGS. 1, 2 and 3.

Preferably, the means and the elements of the device 100 are configured to implement the steps of the method 400 and their embodiments as described above, and the method 400 and its different embodiments can be implemented by the means and elements of the device 100.

1. A device for purifying wastewater, comprising a vacuum anaerobic digester comprising:
in the lower part, an inlet for wastewater, the lower part being configured to receive a bed of microorganisms, the microorganisms comprising bacteria;
in the upper part:
a weir for treated water comprising a water outlet positioned at a first height starting from the lower part; and
a biogas outlet positioned at a second height higher than the first height;
a riser column for raising water by suction of the biogas from the lower part to the upper part;
a downer column for bringing down untreated wastewater from the upper part to the lower part; and
a vacuum pump connected to the biogas outlet and configured to cause, when said pump is actuated, the flow of water from the lower part to the upper part;
a buffer column configured to receive wastewater, the column comprising:
a wastewater inlet; and
an atmospheric air intake;
the inlet for wastewater from the digester being connected to the buffer column and configured to supply wastewater by means of a vacuum.

2. The device according to claim 1, wherein the digester comprises a bottom outlet for treated water, connected to the weir and positioned at a third height starting from the lower part, said third height being lower than the first height of the weir.

3. The device according to claim 2, wherein the third height of the bottom outlet for treated water is lower than the level of wastewater in the buffer column.

4. The device according to claim 2, wherein the bottom outlet for treated water also comprises a valve for extracting water from the weir.

5. The device according to claim 4, which comprises a sensor for detecting the presence of water in the weir, the extraction valve being activated based on the detected presence of water.

6. The device according to claim 1, which also comprises
an inlet for recirculated biogas in the lower part of the digester; and
a recirculation pipe for recirculating biogas from the biogas outlet to the biogas inlet.

7. The device according to claim 6, which also comprises a valve for activating the recirculation pipe.

8. The device according to claim 4, which has a mode of operation in which the valve for activating the recirculation pipe and the water extraction valve are closed.

9. The device according to claim 1, which comprises:
a pressure sensor, configured to detect an operating pressure in the upper part of the digester; and
a proportional-integral-derivative regulator, configured to regulate the operation of the vacuum pump based on the pressure detected in the upper part of the digester.

10. The device according to claim 1, wherein the digester also comprises an open tank, the riser column for raising water by suction of biogas of water comprising, in the upper part of the digester, an outlet for the raised biogas, said outlet being connected to the open tank and positioned at a fourth height lower than the first height.

11. The device according to claim 1, wherein the riser column for raising biogas is at least partially surrounded by a settling zone.

12. The device according to claim 11, wherein a fifth height defining the limit of the settling zone is lower than the first height of the weir.

13. The device according to claim 11, wherein the settling zone comprises a lamella settler.

14. The device according to claim 1, wherein the digester also comprises a gas-liquid-solid separator communicating with a lower end of the water riser column, the separator being substantially conical in revolution and with a top arranged inside the water riser column, and being configured to carry at least biogas in the water riser column.

15. The device according to claim 14, wherein the conical separator has a base, and the digester also comprises a deflector:
arranged at a sixth height lower than the base of the separator;
having an end projecting orthogonally onto the base of the separator; and
configured to direct the flow of biogas towards the base.

16. The device according to claim 1, which also comprises
a level sensor for detecting a wastewater fill level in the buffer column; and
a supply pump for supplying the buffer column with wastewater, activated based on the detected fill level.

17. The device according to claim 1, which also comprises, downstream from the vacuum pump:
a dehumidifier of the biogas;
an adsorption means for purifying the biogas; and/or
a storage for the biogas.

18. The device according to claim 1, wherein the digester comprises a thermal chamber configured to receive a flow of warm water, comprising a water inlet and a water outlet, and a warm water circuit comprising:
a water pump connected to the water outlet of the chamber, and
a heat exchanger configured to heat or cool the warm water, the water on output from the heat exchanger being supplied to the water inlet of the chamber.

19. A method for purifying wastewater, comprising a step of anaerobic digestion under vacuum, in a digester, comprising:
a step of inputting wastewater into the lower part of the digester;
a step of generating a bed of microorganisms in the lower part of the digester, the microorganisms comprising bacteria;
a step of raising water, in the riser column of the digester, from the lower part to an upper part of the digester;
a step of the outflowing of treated water, by a weir in the upper part of the digester, comprising a step of outputting water in a water outlet of the weir for water positioned at a first height;
a step of outputting biogas, through a biogas outlet positioned at a second height higher than the first height;
a step of bringing down wastewater, in a downer column, from the upper part to the lower part of the digester; and
a step of vacuum pumping connected to the biogas outlet and configured to cause, when said pump is actuated, the flow of water from the lower part to the upper part;
a step of inputting wastewater into a buffer column;
a step of intaking atmospheric air into the buffer column; and
a step of supplying, by means of a vacuum, wastewater in the buffer column to the digester, the digester being connected to the buffer column.
